(19) United States
(12) Patent Application Publication
(10) Pub. No.: US 2019/0112005 A1
(43) Pub. Date: Apr. 18, 2019

(54) HYDRAULIC CLUTCH SYSTEM FOR MOTORCYCLE AND METHOD OF USING THE SAME

(71) Applicant: Axel Weller, Las Vegas, NV (US)

(72) Inventor: Axel Weller, Las Vegas, NV (US)

(21) Appl. No.: 15/783,861

(22) Filed: Oct. 13, 2017

(51) Int. Cl. B62M 25/04; F16D 48/02; F16H 59/02; B62M 25/06

(52) U.S. Cl. CPC B62M 25/04; F16D 48/02; F16H 59/02; B62M 25/06; F16D 2500/3146; F16D 2500/10406; F16D 2500/1117; F16D 2500/31413; F16D 2048/0221

(57) ABSTRACT

A hydraulic clutch system for a motorcycle includes a foot pedal for engaging and disengaging a hydraulic clutch via hydraulic fluid in a first hydraulic fluid conduit and a hand clutch lever for engaging and disengaging the hydraulic clutch via hydraulic fluid in a second hydraulic fluid conduit. A solenoid or similar article switches the system between foot pedal and hand clutch lever control based on pressure in hydraulic lines extending from the foot pedal and hand clutch lever to the hydraulic clutch. A pressure switch, micro-switch or similar article communicates with, and activates the solenoid or other article to switch between lines.

### FIELD OF THE INVENTION

The embodiments of the present invention relate to a hydraulic clutch system for a motorcycle.

### BACKGROUND

Except for very few models, motorcycles are manually shifted by the operator. The most common system comprises a foot pedal configured to shift gears while a hand lever is used to disengage power from the crankshaft to the transmission gears. Another system utilizes a hand shifter and foot lever used to disengage power from the crankshaft to the transmission gears (aka “suicide shifter”). The primary drawback with the suicide shifter is the necessity to maintain one foot on the foot lever at all times, including while stopped. Accordingly, the operator only has one foot on the ground to balance the motorcycle.

It would be useful and advantageous to develop a clutch system which removes the drawbacks associated with the motorcycle hand shifter.

### SUMMARY

Accordingly, one embodiment of the present invention involves a hydraulic clutch system comprising: a foot pedal for engaging and disengaging a hydraulic clutch via hydraulic fluid in a first hydraulic fluid conduit; a hand clutch lever for engaging and disengaging said hydraulic clutch via hydraulic fluid in a second hydraulic fluid conduit; a pressure sensor configured to activate a solenoid to maintain said second hydraulic fluid conduit in a closed position when said first hydraulic fluid conduit is in an open position such that said foot pedal is operable to engage and disengage said hydraulic clutch, and maintain said first hydraulic fluid conduit in a closed position when said second hydraulic fluid conduit is in an open position such that said hand clutch lever is operable to engage and disengage said hydraulic clutch.

In one embodiment, a pressure switch proximate to the solenoid triggers the solenoid to open and close the first and second hydraulic conduits. Alternatively, a micro-switch proximate to the hand clutch lever triggers the solenoid to open and close the first and second hydraulic conduits.

With the system detailed herein, the rider may utilize the hand clutch lever during deceleration and accelerating of the motorcycle. The system allows the rider to rest both feet on the ground while stopped since the hand clutch lever may be used to maintain the clutch in a disengaged condition. When ready to accelerate, the hand clutch lever is used to control engagement and disengagement of the hydraulic clutch at which point the system again switches to the foot pedal.

Other variations, embodiments and features of the present invention will become evident from the following detailed description, drawings and claims.

### BRIEF DESCRIPTION OF THE DRAWINGS

FIG. 1A illustrates a pressure switch hydraulic clutch system using a foot pedal according to the embodiments of the present invention;

FIG. 1B illustrates a pressure switch hydraulic clutch system using a hand clutch lever according to the embodiments of the present invention;

FIG. 2A illustrates a micro-switch hydraulic clutch system using a foot pedal according to the embodiments of the present invention; and

FIG. 2B illustrates a micro-switch hydraulic clutch system using a hand clutch lever according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to those skilled in the relevant art and having possession of this disclosure, are to be considered within the scope of the invention claimed.

The embodiments of the present invention are utilized with a motorcycle having a hand shifter configured to allow a rider to shift motorcycle gears. A hand-shifting clutch is also known as a “suicide shifter” in the motorcycle community because of its inherent dangerous nature. With a hand-shifting motorcycle the rider engages and disengages the clutch via a foot pedal on the left side of the motorcycle while shifting gears via a hand-shifter proximate to the motor (e.g., on the left side of the motorcycle and slightly lower than the seat). With such a configuration, when the motorcycle is running and stopped (e.g., at a stop light), the rider must maintain his or her left foot on the foot pedal to keep the clutch disengaged with the motorcycle in first gear waiting to accelerate. Balancing a motorcycle on one foot can be challenging and certainly dangerous as the motorcycle is in gear. On the other hand, a conventional motorcycle includes a hand clutch lever for engaging and disengaging the motorcycle clutch and foot shifter for running through the gears. It is therefore easy to maintain disengagement of the clutch using the hand clutch lever such that the rider may maintain both feet on the ground with the motorcycle in first gear.

As used herein, the term “motorcycle” includes two-wheeled, three-wheeled and four-wheeled motor-powered vehicles.

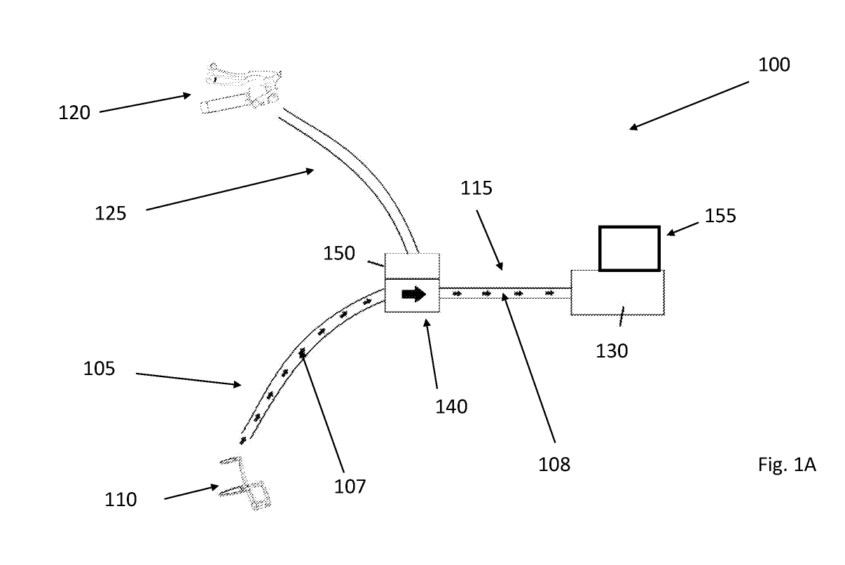

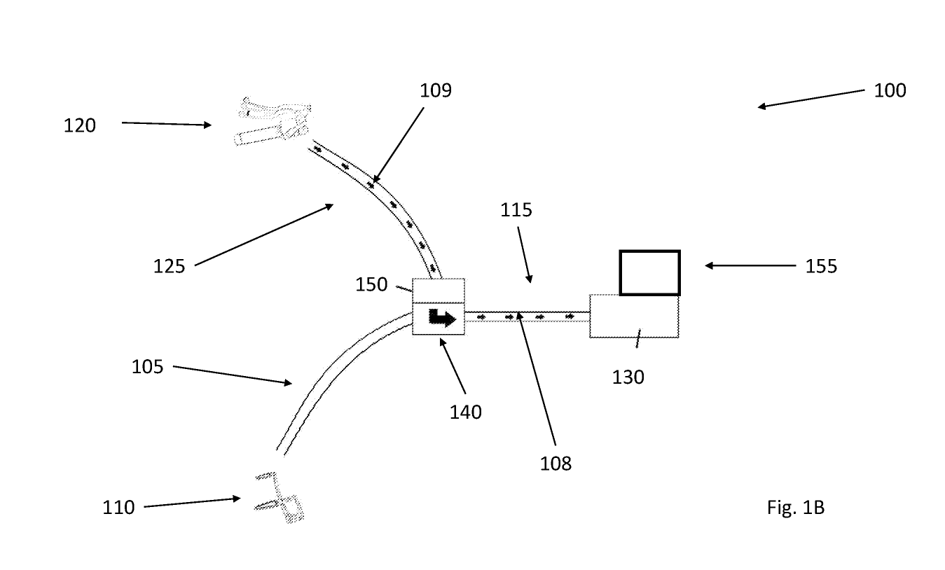

As shown in FIGS. 1A and 1B, a system 100 broadly comprises a foot pedal 110, hand clutch lever 120, hydraulic clutch 130, solenoid 140 and pressure switch 150. A hand shifter 155 permits a rider to shift gears.

Lines or tubes 105 and 115 form a first hydraulic fluid conduit and lines 125 and 115 form a second hydraulic fluid conduit. As best seen in FIG. 1A, hydraulic fluid 107 in line 105 and hydraulic fluid 108 in line 115 provides means for the hydraulic clutch 130 to be engaged and disengaged via foot pedal 110 while hydraulic fluid 109 in line 125 and hydraulic fluid 108 in line 115 provides means for the hydraulic clutch 130 to be engaged and disengaged by hand clutch lever 110.

As shown in FIGS. 1A and 1B, solenoid 140 is positioned at the junction of line 105 and line 115. Solenoid 140 is configured as a valve to switch between line 105 and line 115 depending on whether the foot pedal 110 or hand clutch lever 120 is being used to engage and disengage the hydraulic clutch 130. As shown in FIG. 1A, when line 105 is open and line 125 is closed, line 105 communicates with line 115 to create a complete hydraulic fluid conduit between foot pedal 110 and hydraulic clutch 130 allowing the foot pedal 110 to control engagement and disengagement of the hydraulic clutch 130. As shown in FIG. 1B, when line 125 is open and line 105 is closed, line 125 communicates with line 115 to create a complete hydraulic fluid conduit between hand clutch lever 120 and hydraulic clutch 130 allowing the hand clutch lever 120 to control engagement and disengagement of the hydraulic clutch 130. As such, either foot pedal 110 or hand clutch lever 120 controls the hydraulic clutch 130 at a given time.

Switching between foot pedal 110 control of the hydraulic clutch 130 and hand clutch lever 120 control of the hydraulic clutch 130 is accomplished with, in this embodiment, a pressure switch 150 in communication with the solenoid 140. As pressure in the lines 105 and 115 builds and the motorcycle is downshifted during deceleration to a stop, the pressure switch 150 activates the solenoid 140 to close line 105 and open line 125 thereby switching from foot pedal 110 control to hand clutch lever 120 control. As pressure in the lines 125 and 115 builds and the motorcycle is upshifted during acceleration from a stop, the pressure switch 150 activates the solenoid 140 to close line 125 and open line 105 thereby switching from hand clutch lever 120 control to foot pedal 110 control. In this manner, the rider may safely stop with both feet on the ground and resume riding with the hand clutch lever 110 thereby not needing to constantly balance the bike while having one foot on the foot pedal 110 and the other one on the ground while at a stop.

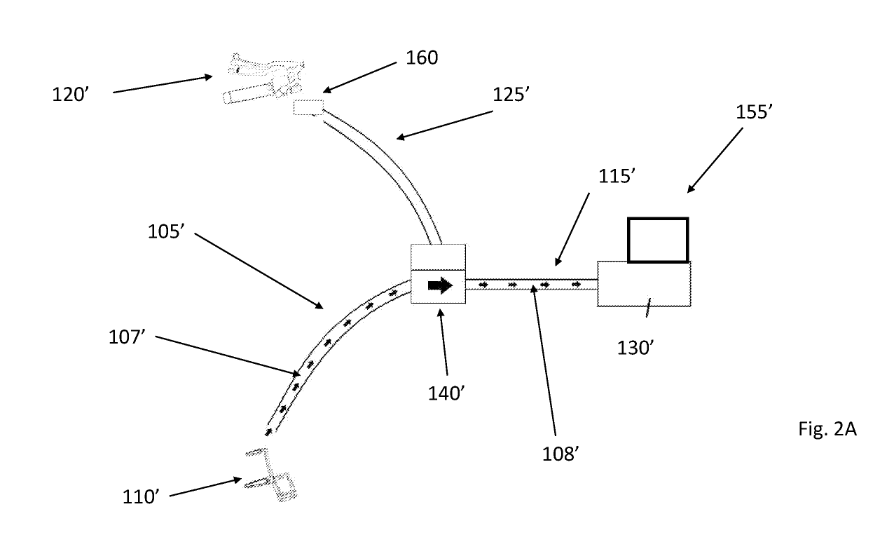

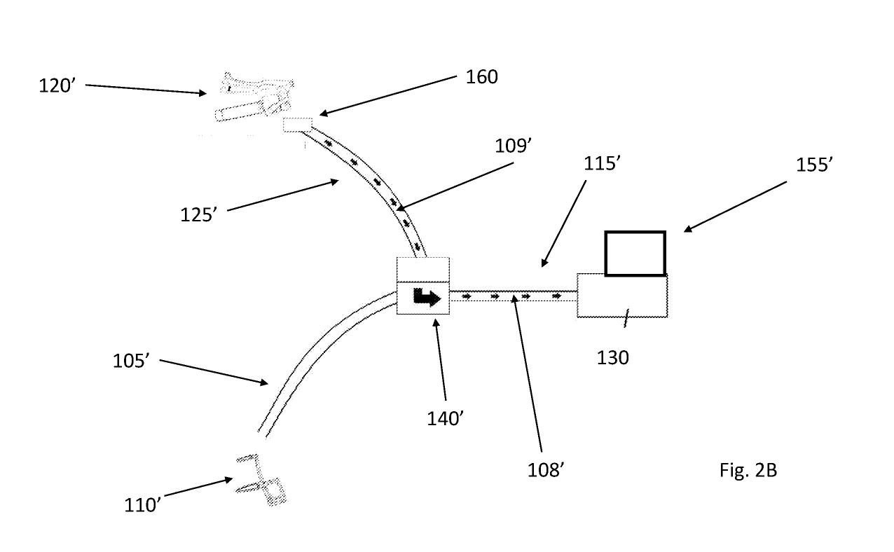

Now referring to FIGS. 2A and 2B, in an alternative embodiment, a system 100′ broadly comprises a foot pedal 110′, hand clutch lever 120′, hydraulic clutch 130′, solenoid 140′ and micro-switch 150′. A hand shifter 155′ permits a rider to shift gears.

Lines or tubes 105′ and 115′ form a first hydraulic fluid conduit and lines 125′ and 115′ form a second hydraulic fluid conduit. As best seen in FIG. 2A, hydraulic fluid 107′ in line 105′ and hydraulic fluid 108′ in line 115′ provides means for the hydraulic clutch 130′ to be engaged and disengaged via foot pedal 110′ and, as best seen in FIG. 2B, hydraulic fluid 109′ in line 125′ and hydraulic fluid 108′ in line 115′ provides means for the hydraulic clutch 130′ to be engaged and disengaged by hand clutch lever 120′.

The micro-switch 160 proximate to, or integrated within, the hand clutch lever 120′. In this embodiment, switching between foot pedal 110′ control of the hydraulic clutch 130′ and hand clutch lever 120′ control of the hydraulic clutch 130′ is accomplished with micro-switch 160 in communication with solenoid 140′. As pressure in the lines 105′ and 115′ builds and the motorcycle is downshifted during deceleration to a stop, the micro-switch 160 activates the solenoid 140′ to close line 105′ and open line 125′ thereby switching from foot pedal 110′ control to hand clutch lever 120′ control. As pressure in the lines 125′ and 115′ builds and the motorcycle is upshifted during acceleration from a stop, the micro-switch 160 activates the solenoid 140′ to close line 125′ and open line 105′ thereby switching from hand clutch lever 120′ control to foot pedal 110′ control. In this manner, the rider may safely stop with both feet on the ground and resume riding with the hand clutch lever 110′ thereby not needing to constantly balance the bike while having one foot on the foot pedal 110′ and the other one on the ground while at a stop.

Those skilled in the art with recognize that the solenoid 140, 140′, pressure switch 150 and micro-switch 160 are exemplary electro-mechanical components that may be replaced with other electro-mechanical components performing the same or similar task without departing from the spirit and scope of the present invention.

As set forth above, the solenoid 140, 140′ may act as a valve to open one line and close the other line simultaneously responsive to a pressure inside the lines as detected by a pressure switch or micro-switch. The valve means may be any mechanism configured to open one line and close the other line simultaneously. The valve means may also be triggered based on feedback other than pressure in the lines such as speed of the motorcycle or the gear in which the transmission is engaged (e.g., in first gear the hand clutch lever may control engagement and disengagement of the hydraulic clutch). It is conceivable that the rider may manually trigger the valve means to select the foot pedal or hand clutch lever (e.g., via a toggle on the handlebars).

Although the invention has been described in detail with reference to several embodiments, additional variations and modifications exist within the scope and spirit of the invention as described and defined in the following claims.

I claim:

1. A hydraulic clutch system for a motorcycle comprising:
a foot pedal for engaging and disengaging a hydraulic clutch via hydraulic fluid in a first hydraulic fluid conduit;
a hand clutch lever for engaging and disengaging said hydraulic clutch via hydraulic fluid in a second hydraulic fluid conduit; and
automated valve means for causing said second hydraulic fluid conduit to remain in a closed position when said first hydraulic fluid conduit is in an open position such that said foot pedal is operable to engage and disengage said hydraulic clutch, and for causing said first hydraulic fluid conduit to remain in a closed position when said second hydraulic fluid conduit is in an open position such that said hand clutch lever is operable to engage and disengage said hydraulic clutch.

2. The hydraulic clutch system of claim 1 wherein said automated valve means opens and closes said first hydraulic fluid conduit and second hydraulic fluid conduit based on pressure within said first hydraulic fluid conduit and second hydraulic fluid conduit.

3. A hydraulic clutch system for a motorcycle comprising:
a foot pedal for engaging and disengaging a hydraulic clutch via hydraulic fluid in a first hydraulic fluid conduit;
a hand clutch lever for engaging and disengaging said hydraulic clutch via hydraulic fluid in a second hydraulic fluid conduit; and
a pressure switch configured to activate a solenoid to close said second hydraulic fluid conduit when said first hydraulic fluid conduit is in an open position such that said foot pedal is operable to engage and disengage said hydraulic clutch, and close said first hydraulic fluid conduit when said second hydraulic fluid conduit is in an open position such that said hand clutch lever is operable to engage and disengage said hydraulic clutch.

4. The hydraulic clutch system of claim 3 wherein said solenoid is positioned proximate to a junction of hydraulic lines extending from said foot pedal and said hand clutch lever.

5. The hydraulic clutch system of claim 3 further comprising a hand shifter configured to shift motorcycle gears.

6. The hydraulic clutch system of claim 3 wherein said first hydraulic fluid conduit comprises a line extending from said foot pedal to said solenoid and a line extending from said solenoid to said hydraulic clutch.

7. The hydraulic clutch system of claim 3 wherein said second hydraulic fluid conduit comprises a line extending from said hand clutch lever to said solenoid and a line extending from said solenoid to said hydraulic clutch.

8. A hydraulic clutch system for a motorcycle comprising:
a foot pedal for engaging and disengaging a hydraulic clutch via hydraulic fluid in a first hydraulic fluid conduit;
a hand clutch lever for engaging and disengaging said hydraulic clutch via hydraulic fluid in a second hydraulic fluid conduit; and
a micro-switch configured to activate a solenoid to maintain said second hydraulic fluid conduit in a closed position when said first hydraulic fluid conduit is in an open position such that said foot pedal is operable to engage and disengage said hydraulic clutch, and maintain said first hydraulic fluid conduit in a closed position when said second hydraulic fluid conduit is in an open position such that said hand clutch lever is operable to engage and disengage said hydraulic clutch.

9. The hydraulic clutch system of claim 8 wherein said solenoid is positioned proximate to a junction of hydraulic lines extending from said foot pedal and said hand clutch lever.

10. The hydraulic clutch system of claim 8 further comprising a hand shifter configured to shift motorcycle gears.

11. The hydraulic clutch system of claim 8 wherein said first hydraulic fluid conduit comprises a line extending from said foot pedal to said solenoid and a line extending from said solenoid to said hydraulic clutch.

12. The hydraulic clutch system of claim 8 wherein said second hydraulic fluid conduit comprises a line extending from said hand clutch lever to said solenoid and a line extending from said solenoid to said hydraulic clutch.
